(19) United States
(12) Patent Application Publication
(10) Pub. No.: US 2026/0301082 A1
(43) Pub. Date: Oct. 1, 2026

(54) SYSTEM AND METHOD FOR STANDARDIZED INTERACTIONS WITH WEBSITE FORMS

(71) Applicant: Remitian Inc., Miami, FL (US)

(72) Inventors: Larry HASSON, Ottawa (CA); Pierre-Olivier CHARLEBOIS, Ottawa (CA); Solon ANGEL, Ottawa (CA)

(21) Appl. No.: 19/630,340

(22) Filed: Mar. 26, 2026

Related U.S. Application Data
(60) Provisional application No. 63/777,823, filed on Mar. 26, 2025.

(51) Int. Cl. G06Q 40/12

(52) U.S. Cl. CPC G06Q 40/123

(57) ABSTRACT

System and method that provide a single, standardized platform for submission of user information to websites. User data/user input is retrieved from a source, such as an existing database or a real-time user interface, by a central server. The server also retrieves information regarding a designated entity at which the submission is to be made. This information generally comprises a predetermined mapping of a submission website/portal of the designated entity. The server deploys a software agent to interact with the website based on the mapping. The agent populates available website fields with the user data and thereby completes at least a portion of the submission. The system in some embodiments also monitors the website(s) and detects changes in the required data over time. In some embodiments, agents may interact with multiple websites in respect of a single set of user data.

### RELATED APPLICATIONS

This application is a non-provisional patent application which claims the benefit of U.S. Provisional Application No. 63/777,823 filed on Mar. 26, 2025.

### TECHNICAL FIELD

The present invention relates to electronic form filling. More specifically, the present invention relates to simplifying and standardizing user interactions with existing and/or legacy systems.

### BACKGROUND

Many administrative tasks, for both individuals and businesses, currently involve submitting information on a website/web platform/web portal. For example, many tasks such as rental applications, job applications, enrolling with new healthcare providers, paying utility bills, and paying taxes generally require users to login to specific websites/portals/platforms maintained by the relevant organization(s) or authority. (For clarity, the term ‘website’ used herein should be taken to mean any such website/web portal/web platform that is publicly accessible over a network, including but not limited to global networks such as the Internet.) However, much of the information that must be entered at such websites is redundant, detailed, and complex, and the penalties for inaccuracy can be high. Manual re-entry of information into multiple pre-existing and complex systems can thus be very challenging and high-risk.

As one example, the complexity of tax systems varies depending on the country and the jurisdiction, and may involve federal, provincial, state, and/or municipal taxes. In many cases, taxes are calculated based on a combination of factors, such as income, deductions, credits, and exemptions, and may be subject to a variety of rules and regulations. Awareness of the differences between each tax system, and how to enter data correctly for each jurisdiction, is highly onerous, and inaccurate submissions may result in steep fines and even, in some cases, imprisonment.

In particular, individuals and businesses that must remit taxes in multiple jurisdictions face a high burden when navigating multiple separate websites to input largely similar information. Examples of such disparate websites are shown in FIGS. 1A to 1D. As can be seen, each website may require separate access credentials and separate manual data entry. However, much of the information entered (e.g., Social Security Number or Social Insurance Number, business numbers and names, registered address(es), etc.) may be the same from website to website. The duplicative nature of much of this data entry exposes the process to human error and confusion. As such, automating tax submissions would be a significant benefit.

However, automating such processes has conventionally been a challenge of its own. In particular, the websites maintained by the various authorities/entities are frequently legacy systems that do not comply with modern programming standards or norms, that have non-standardized interfaces, and/or that lack application programming interfaces (APIs). This lack of interoperability has historically made it difficult to automate interactions with multiple systems.

There is thus a need for systems and methods that can interact with multiple existing website form systems with little to no human input required.

### SUMMARY

This document discloses a system and method that provide a single, standardized platform for submission of user information to websites. User data/user input is retrieved from a data source, such as an existing database or a real-time user interface, by a central server. The server also retrieves information regarding a designated entity/organization/authority/agency (at which the submission is to be made). This information generally comprises a predetermined mapping of a submission website/portal of the designated organization/authority/agency. The server deploys a software agent to interact with the website based on the mapping. The agent populates available website fields with the user data and thereby completes at least a portion of the submission. The system in some embodiments also monitors the website(s) and detects changes in the required data over time. In some embodiments, agents may interact with multiple websites in respect of a single set of user data.

In a first aspect, this document discloses a system for standardizing submissions to tax-filing websites, said system comprising: a server configured to retrieve user data from a data source, said user data relating to at least one tax submission to be made to at least one of said tax-filing websites; at least one software agent deployed over a network by said server, said at least one software agent being configured to interact with said at least one of said tax-filing websites; and at least one database in communication with said server, said database storing information relating to said at least one of said tax-filing websites, wherein interactions of said at least one software agent with said at least one of said tax-filing websites are based on said information stored in said at least one database, and wherein said interactions relate to at least part of said at least one tax submission.

In another embodiment, this document discloses a system wherein said data source is at least one of: said at least one database; an additional database; an external system; a third-party system; and a user interface receiving data input from a user in real or near-real time.

In another embodiment, this document discloses a system wherein said server is further configured to monitor said at least one of said tax-filing websites and to thereby determine a state of said at least one of said tax-filing websites.

In another embodiment, this document discloses a system wherein said server determines a change in said state of said at least one of said tax-filing websites.

In another embodiment, this document discloses a system wherein said change in said state comprises a change in data requirements of said at least one of said tax-filing websites.

In another embodiment, this document discloses a system wherein said server is further configured to provide feedback to an operator of said system, said feedback detailing said change in said state.

In another embodiment, this document discloses a system wherein said server is further configured to automatically adjust said information in said database based on said change in said state.

In another embodiment, this document discloses a system wherein said change in said state of said at least one of said tax-filing websites is recorded in said database.

In another embodiment, this document discloses a system wherein said server is further configured to automatically adjust a user interface based on new information recorded in said database.

In another embodiment, this document discloses a system wherein said at least one software agent comprises a plurality of software agents and wherein each of said plurality of software agents is configured to interact with a different tax-filing website.

In another embodiment, this document discloses a system wherein multiple software agents of said plurality of software agents are deployed on a single set of user data.

In another embodiment, this document discloses a system wherein said multiple software agents operate simultaneously.

In a second aspect, this document discloses a method for standardizing submissions to tax-filing websites, said method comprising: (a) retrieving, by a server, user data from a data source, said user data relating to at least one tax submission to be made; (b) receiving a designation of at least one tax authority; (c) determining, by said server, a mapping of said user data to data fields of a tax-filing website of said at least one tax authority; and (d) deploying, over a network using said server, a software agent configured to interact with said tax-filing website, wherein said software agent interacts with said tax-filing website based on said mapping and on said user data, to thereby complete at least a part of said at least one tax submission based on said user data.

In another embodiment, this document discloses a method wherein step (c) comprises retrieving at least part of said mapping from a database.

In another embodiment, this document discloses a method wherein step (c) comprises generating at least part of said mapping using a mapping-capable software agent.

In another embodiment, this document discloses a method further comprising monitoring said website to thereby determine a state of said tax-filing website.

In another embodiment, this document discloses a method further comprising determining a change in said state of said tax-filing website.

In another embodiment, this document discloses a method wherein said change in said state comprises a change in data requirements of said tax-filing website.

In another embodiment, this document discloses a method further comprising providing feedback to an operator of said server, said feedback detailing said change in said state.

In another embodiment, this document discloses a method further comprising automatically adjusting said mapping based on said change in said state.

In another embodiment, this document discloses a method further comprising deploying a plurality of software agents in step (c), wherein each of said plurality of software agents is configured to interact with a different tax-filing website.

In another embodiment, this document discloses a method wherein said plurality of software agents are simultaneously deployed.

In another aspect, this document discloses a system for standardizing interactions with websites, said system comprising: a server configured to retrieve user data from a data source, said user data relating to at least one submission to be made to at least one of said websites; at least one software agent deployed over a network by said server, said at least one software agent being configured to interact with said at least one of said websites; and at least one database in communication with said server, said database storing information relating to said at least one of said websites, wherein interactions of said at least one software agent with said at least one of said websites are based on said information stored in said at least one database, and wherein said interactions relate to at least part of said at least one submission.

### BRIEF DESCRIPTION OF THE DRAWINGS

The present invention will now be described by reference to the following figures, in which identical reference numerals refer to identical elements and in which:

FIGS. 1A to 1D are screenshots of various existing tax authority websites according to the prior art;

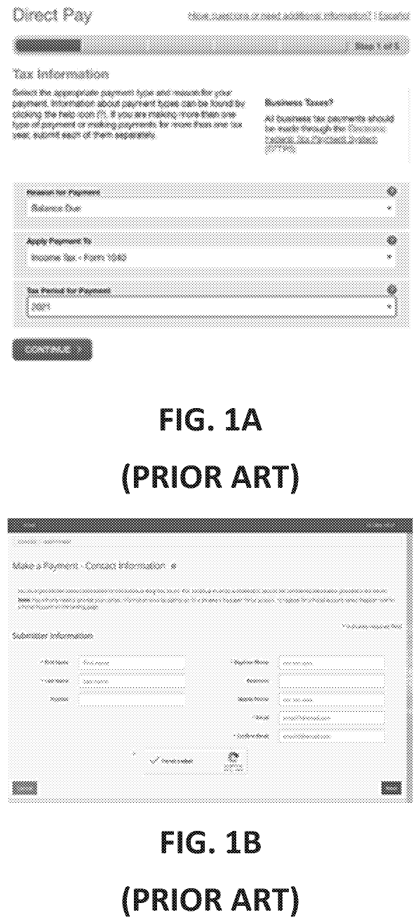

FIG. 2 is a block diagram of a system according to one aspect of the invention;

FIG. 3 is a block diagram of another embodiment of the system of FIG. 2;

FIG. 4 is a flowchart detailing a method according to another aspect of the invention;

FIG. 5 is a flowchart detailing another embodiment of the method of FIG. 4; and

FIG. 6 is a flowchart detailing a method of monitoring websites according to the present invention.

### DETAILED DESCRIPTION

The present invention provides a system and method that standardizes and simplifies interactions with website forms. The system provides a single platform for making submissions to multiple websites. User data/user input is retrieved from a data source and a relevant website is designated (i.e., a website/portal at which a submission/filing/application is to be made). The website may be designated by a user or determined by the system based on analysis of the retrieved user data. Multiple websites/portals, potentially corresponding to multiple entities (i.e., organizations/authorities/agencies), may be simultaneously designated to receive the input. Once the user data is retrieved and at least one entity/website is designated, a server retrieves information regarding the selected at least one entity from a database. The information generally comprises a predetermined mapping of a submission website of the selected entity. Based on that information/mapping, a software agent interacts with the website, populating available fields with data provided by the user. In one embodiment, when the submission is completed on the website, a notification is provided to the user.

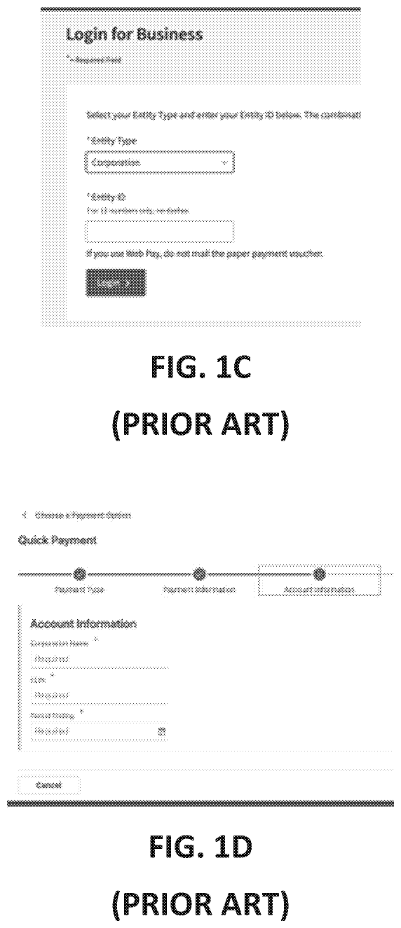

A block diagram of a system 10 according to one aspect of the invention is shown in FIG. 2. The central server 20 is in communication with the database 60, with a software agent 30, and indirectly with a website/portal 40 by way of a network. The network is depicted in FIG. 2 as a cloud. The network, depending on the embodiment and without limitation, comprises a local area network (LAN), a wide area network (WAN), and/or the Internet. The server 20 may communicate with the database 60 and the agent 30 by way of the network (not shown in FIG. 2), by way of wired connections (including, e.g., an internal data bus, for components that form a single physical unit), or by any other suitable connection mechanism.

Similarly, the server 20 may comprise a single physical server unit or multiple physical server units that are in physical proximity to each other and that are connected to each other using wired connections. In other embodiments, the server 20 may comprise one or more remote server units and/or processors connected by wireless connections, including both short-range connection protocols and/or long-range connection protocols. Nothing in FIG. 2 or elsewhere in this disclosure should be considered to restrict any such implementations.

Similarly, again, it should be understood that the depiction of a single database 60 is purely for visual convenience. In some embodiments, the system 10 comprises multiple databases 60, all of which may be in communication with the server 20. As a non-limiting example, one database 60 may store user data while another database 60 stores information relating to various website mappings. Any suitable number of databases may be used, depending on the implementation, and nothing in this disclosure should be considered to limit the number or configuration of such databases or other data stores that may be known in the art.

In one embodiment, the central server 20 is also in communication with at least one user device 50. In such embodiments, a submission interface may be implemented on the at least one user device 50 and allow for user input to be entered and transmitted to the server as described above. (That is, in such embodiments, the user device 50 may comprise at least one of the data sources from which user data is retrieved.) As should be understood, the depiction of the user device 50 as a smartphone in FIG. 2 is purely for pictorial convenience. The user device 50 may comprise a laptop or desktop computer, a mobile computing device such as a tablet, smartphone, or purpose-built handheld device, and/or any other device able to run the submission interface and send and receive data. It should also be noted that a specific user may, depending on the embodiment, use multiple different user devices at different times.

It should also be understood that, in some embodiments, the user device 50 may be directly connected to the server 20 by a wired connection. For example, if the system 10 is implemented at an accounting or tax preparation firm for the purpose of tax submissions, there may be physical (wired) connections between the server 20 and the user device 50. Nothing in FIG. 2 or elsewhere in this disclosure should be considered to restrict such an implementation where suitable.

### Software Agent 30

The server 20 deploys an agent 30 over a network, such as the Internet, to interact with the various websites 40A . . . 40n. The term “agent”, as used herein, refers to a software agent (i.e., a software component, module, or program) that interacts with remote data sources, structures, and servers. Such a software agent may also be referred to as a robot, web robot, bot, and/or crawler. The techniques of Robotic Process Automation (RPA) enable such an agent to perform repetitive digital tasks, such as copying and pasting data, transferring files, filling forms, and other comparatively straightforward tasks which require high accuracy but may be tedious and time-consuming. In general, such software agents/robots are instantiated at a server and deployed (i.e., used) on public-facing websites. As should be understood, such software agents may be created on an as-needed or temporary basis, or may be persistent (i.e., created once and re-called or re-tasked as needed). In some embodiments, a system may be configured to create one or more such temporary software agents and to include one or more persistent software agents.

Such software agents may act to transfer data between their host server and the website over a network. Data may be transferred in this way from the server to the website (and thereby to servers and/or data storage associated with the target website). Similarly, data may be gathered at a website by a software agent and communicated back to the agent's host server.

It should therefore be understood that the agent 30 in FIG. 2 may, in some embodiments, be a component of the server 20 and/or comprise software that is implemented using the processing circuitry of the server 20. That is, the distinction between the agent 30 and the server 20 in the present figures should be understood as being for visual simplicity and ease of understanding. This depiction of a separate ‘agent’ 30 is not intended to limit the possible implementations of a software agent that may be available to the person skilled in the art.

Further, it should be understood that the number of agents deployed/implemented by the server is not limited to the single robot shown in FIG. 2. The server may deploy any number of agents at any time, including simultaneous deployment in some embodiments. In some embodiments, a single agent may be configured to interact with a number of different websites. For example, a “general-purpose” submission agent may be able to input data to multiple different websites, provided that suitable mappings for those multiple websites are available in the database 60. Depending on the embodiment, one or more agents may be configured to determine a suitable mapping for one or more websites, as well as to input data to those websites. Such agents may determine the mapping during the data input process (e.g., by searching for appropriate fields and outputting or logging decisions made during the input process). Instructions for the software agent(s) to determine such mappings may be computer-readable and/or human-readable, and may comprise code and/or metadata within the software agent(s). The mappings/logs may be stored in the database 60 or in another data storage system. Additionally, in some embodiments, as elsewhere described, a first software agent may be configured to determine a mapping for a website and a second software agent may be configured to input data accordingly.

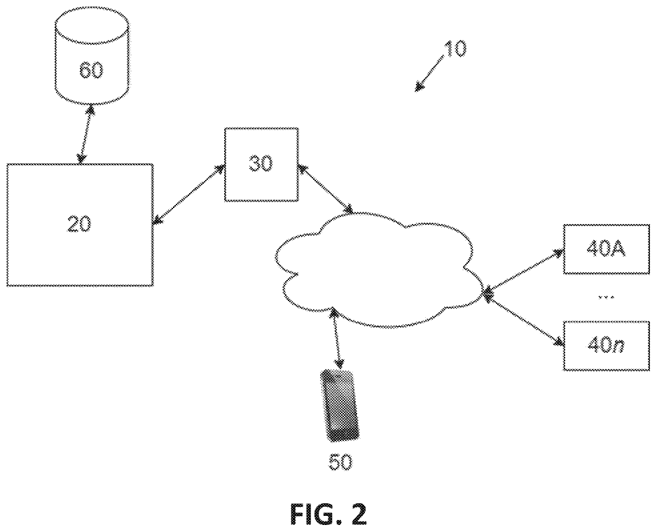

Alternatively or additionally, in some embodiments, a plurality of agents may be used in the system 10. In some embodiments, each of the plurality of agents may be configured to access and interact with a different website. For example, one agent may be configured to interact with the IRS (the US Internal Revenue Service) website while another agent may be configured to make submissions on the State of California's web portal for tax filing. Such a system is depicted in FIG. 3, which is similar to FIG. 2 except for the plurality of agents 30 . . . 30i.

In some embodiments that use multiple dedicated agents (e.g., agents configured for specific sites), one or more of the dedicated agents may be preconfigured and its associated code/programming stored in the system (e.g., in the database 60). For example, if the system 10 is used in the US for tax filings, a preconfigured agent for making tax submissions to the IRS may be created and kept in the system at all times. This would reduce the time and computational power required to reconfigure an IRS-submission agent whenever one is needed.

However, in other embodiments, agents may simply be configured on an as-needed basis. That is, an agent may be created/instantiated based on the user input and on the information retrieved. It should also be understood that, in some embodiments, multiple agents are instantiated simultaneously based on a single user input. That is, in some embodiments, a user designates multiple tax agencies/authorities at which submissions/filings are to be made and enters information relevant to all submissions (e.g., bulk income, jurisdiction-specific income, etc.). The agent then uses mappings for each relevant website and inserts user data as appropriate. This further reduces the burden on the user. Such multiple submissions, of course, may be performed simultaneously by the system or “queued” by the system for sequential performance, depending on the embodiment.

### Website Information/Mapping

As referenced above, the database 60 stores information related to the websites. As noted, in some embodiments, the database 60 comprises multiple databases or data storage systems, which may include without limitation a database of mappings, a database of other information related to the entities, and/or a database of user information/user input data. Further, as should be understood, the database(s) may comprise multiple separate databases/data stores, including remote databases/data stores, or may comprise a unitary database comprising all data required to give effect to the system and method herein. The mapping for each website may comprise a correspondence table or a listing of data fields on the website and corresponding data fields from the data source. The mapping may be stored as a JSON file or in any other suitable format. In some embodiments, the mapping comprises multiple inter-related files, each file representing a different aspect of the website. As a non-limiting example, a mapping may comprise a record of the human-viewable/human-readable website information (e.g., text and images that would be displayed on screen to a human user of the website), a record of structural positioning of website elements (e.g., absolute and/or relative DOM positioning data), a record of navigation/interaction instructions (e.g., for website forms that are presented as multiple forms/interfaces), and a record of dependencies between website fields. The mapping is, in some embodiments, predetermined. In other embodiments, the mapping may be determined/generated/constructed during a data input process, as described above. Further, the mapping may be determined/generated/constructed by one or more humans and/or by a further software agent. For example, the mapping in some embodiments is constructed using a web crawler or scraper bot that records the structure of the website and attempts to match labeled fields in the website's form(s) to data fields of the data source. The matching attempt(s) may use one or more predetermined dictionaries and/or synonym lists to identify corresponding words (and thereby identify corresponding fields). The matching attempt(s) may also use the underlying HTML and/or XML structure of the website, Document Object Model (DOM) information for the website, and/or similar structural information of the website, to map entity fields with form input fields. Such structural information may also be used to determine and reproduce a sequence of interactions required to navigate from one web form to the next (i.e., when the website to be filled comprises a plurality of linked forms/interfaces). The matching attempt(s) may also use machine learning processes and/or artificial intelligence techniques, including without limitation natural language processing (NLP) and generative AI, to identify corresponding words and/or structural information (and thereby identify corresponding fields). In some embodiments, both predetermined dictionaries/lists and machine-learning based processes are used. A mapping generated/constructed by such a software agent is, in some embodiments, reviewed by a human.

By reference to the mapping stored in the database 60, the agent determines which website fields to populate with which user input data. For example, the data source may have separate fields for both “First Name” and “Middle Name”, while a specific website may have entry fields for “First Name” and “Middle Initial” only. In such a case, the agent would insert the user data associated with the label “First Name” in the website's “First Name” field. This agent would also truncate the user data associated with the label “Middle Name” and enter only the first letter in the website's “Middle Initial” field. Other discrepancies may be recorded in the mapping and handled by the agent(s) as needed. In addition to referencing logged discrepancies, some embodiments may determine discrepancies in real-time/near-real time, based on, e.g., semantic similarity. That is, if a mapping has not yet been updated but fields have changed (or if no mapping for a specific website has been created yet), in some embodiments, the agent(s) may identify and resolve discrepancies using dictionaries, natural language processing methods, semantic ranking, etc. For example, if a term on a website form is found and is not directly or already mapped to a field in the input data, the term may be compared to all terms used in the input data field names. Results of the comparisons may be determined as semantic similarity scores. The agent, in such embodiments, may determine that input data from the field with the highest semantic similarity score to the website term should be input to the website. Of course, in some embodiments, a lower bound/cut-off threshold may be applied to the semantic similarity scores, such that terms are not considered sufficiently similar if their scores are under the cut-off threshold. For example, if the cut-off threshold is set at 70% and the highest similarity score for a given term on a given website is only 65%, an agent would designate no input field as corresponding to the website term. In such an example, the agent may report an error in respect of the website term and may require human review/input in order to continue. In other embodiments, the agent may queue a report/log in respect of the website term to a “Dead Letter Queue” (i.e., a queue of failed matches). Reports in this queue may be accessed at a later point and the queued terms retried. Website Monitoring

As should be understood, form-based websites (like other websites) may change over time, with or without warning. Accordingly, in some embodiments, the system 10 monitors the data required by the website(s). This monitoring generally uses one or more additional software agent(s). Depending on the embodiment, some of these agents may also be tasked with data input tasks. In some embodiments, dedicated monitoring-only agents may also exist/be regularly created. These agents monitor each tax authority website and determine any changes in the state of the website. For example, the “state” may comprise the public-facing website code (e.g., structural information such as HTML, XML, DOM data), extracted from the website and stored for later comparison purposes in the database 60. At a later point (e.g., on a weekly, monthly, or other basis), the monitoring agent may extract the public-facing website code again and perform a line-by-line comparison with the previously extracted version. If a difference is detected, further actions may be taken. The state may also comprise metadata of the website(s), such as without limitation recorded “last change” dates.

In other embodiments, the “state” comprises a compressed representation of the website. For example, the state may comprise a vector or array in which each element corresponds to a specific common features of tax authority websites. An exemplary array includes elements for, among other fields, “First Name”, “Last Name”, “Middle Name”, “Middle Initial”, “Business Name”, “Business Number”, “SSN”, “SIN”, “Age”, “Address”, “Income”, “Deduction (401k)”, “Deduction (RRSP)”, and so forth. The array may also comprise navigational instructions for navigating between forms/interfaces on the website(s). Depending on the embodiment, the navigational instructions may be stored as data in cells of the array or may be encoded in the structure of the array. For example, in multi-row arrays, the first row of the array may correspond to information to be entered on the first form encountered on a specific website. The second of the array may correspond to information to be entered on the second form encountered on the website, and so on. As should be understood, specific columns may correspond to specific forms, instead of or in addition to row-based correspondences. Other structural representations of the website may also be recorded in the state vector/state array, either as cell data or by way of the structure of the state vector/state array, or both.

In one embodiment, a binary array is used. That is, if a specific tax authority website requires one of the fields in the array above to be entered, the corresponding element would be a ‘1’, while if that specific tax authority website does not require a particular field in the array above to be entered, the element corresponding to that particular field would be a ‘0’. (Note that a binary array of this type may comprise numeric data and/or Boolean data.) Determining a change in state in such an embodiment would involve comparing a newly determined binary vector/array to a previously determined binary vector/array and identifying any elements that have switched from 1 to 0 or vice versa. (Note that switching in such an embodiment would indicate that a field that previously was not required is now required, or that a field that previously was required is no longer required.)

In other embodiments, data in such a state array may fall into more than two categories/options. In one non-limiting example, each entry in a state array corresponds to one of three options (i.e., the array is a ternary array). These options may be/may correspond to ‘Data Required’, ‘Data Optional’, and ‘Data Absent/Not Requested’ statuses for the various possible input fields. For example, a website form/portal may require a surname and accept (but not require) a middle name. In that example, a field of the state array representing the last name would have a state corresponding to ‘Data Required’ and a field of the state array representing the middle name would have a state corresponding to ‘Data Optional’. In such embodiments, the array data may again be numeric (i.e., with 0, 1, 2 or 1, 2, 3, corresponding to the different options, etc.), or may be non-numeric data, including without limitation character and/or string data.

In other embodiments, the state array may include other, field-specific data, such as string data (e.g., text data) indicating that a field of “Last Name” is required at the tax authority website but is referred to as “Surname”. (In such an implementation, the state may share some characteristics with the mapping.) Again, determining a change in state in such an embodiment would involve comparing a new state array to a previous state array and identifying any differences.

In some embodiments, further, the state may comprise dependency information. For example, in some forms, selecting a first option A allows the later selection of options A.1 and A.2. In contrast, selecting an option B as the first option may block the later selection of A.1 and A.2 but allow the later selection of B.1, B.2, and B.3. Again, such information may be tracked as part of the website state (e.g., represented in the structure of a state array).

A determined/detected change in the state of a website is, in some embodiments, recorded in the database 60. The change may be added to an existing record or mapping for the website or comprise an adjustment of that record/mapping. That is, in some embodiments, the database 60 stores historical information for the website(s) in addition to current information that reflects the change. In other embodiments, the database 60 stores only the most current information for any website.

Once a change in the state of the website is determined to have occurred, the system 10 may take multiple actions, depending on the embodiment. One action that may be taken is to provide feedback detailing the change to an operator/administrator of the system 10. The operator/administrator of the system may consider the change and determine whether any adjustments to the mapping information are required. For example, in embodiments where determining a change requires assessing all of the website's code, a change in background colour could be identified as a change in state. However, cosmetic changes of this type should not affect the mapping of the fields of the website to the user input fields, and the change could be safely ignored. On the other hand, changing the title/label of an entry field on the website (e.g., from “Family Name” to “Surname”) would likely require an adjustment to the mapping. Accordingly, the human operator receiving a change notification in such an implementation would decide how to proceed.

Another action that the system 10 may take in response to a determined change in state of the tax authority website is to automatically adjust the mapping without requiring human intervention. For example, if the title of the “Family Name” entry field were changed on the website to “Surname” in such an embodiment, the monitoring agent would direct the server 20 to update the mapping in the database 60 without waiting for approval from a human operator. In some embodiments, the monitoring agent references a predetermined list of synonyms or approved terms to determine whether to make such an adjustment without human approval. In some embodiments, the monitoring agent uses machine learning and/or artificial intelligence techniques to determine whether to make such an adjustment without human approval. In some embodiments, whether to make such an adjustment without human approval is determined by an assessment of a ‘confidence score’ in respect of the adjustment; that is, a potential adjustment is assessed by at least one agent and a confidence score is determined by the at least one agent based on that assessment. The confidence score indicates the probability that the adjustment is correct. In some embodiments, the agent may compare a determined confidence score to a predetermined confidence threshold. If the confidence score for an adjustment is above the confidence threshold, the adjustment proceeds. If the confidence score is below the confidence threshold, the adjustment does not proceed and the adjustment may be sent for human review.

Still another action that the system 10 may take may be to adjust the submission interface displayed to the user (in embodiments that use such an interface). For example, if the system 10 is deployed in a country that introduces a new identification numbering system for businesses, an entry field may be automatically added to the submission interface. Although human oversight may be preferred for adjustments to the submission interface, the system 10 may be capable of making such adjustments on its own (i.e., without human intervention).

As well, in some embodiments, the monitoring agent ignores the changes in website state. It should generally be understood that changes on the website that affect one or more data entry fields are significant changes, and may require user review. However, as one example, the monitoring agent may be programmed to detect ‘purely cosmetic’ changes to the website and take no further action. Depending on the embodiment, such cosmetic changes may include moving an existing field to another position on the same website form, or to another form section on the same website. Cosmetic changes in other embodiments may be considered to only include visual changes (e.g., changes to website colour, font and font stylization, and changes to non-substantive website imagery). To avoid incorrectly categorizing a change as ‘cosmetic’ and thereby incorrectly ignoring the change, a list of types of cosmetic changes (and/or other changes that may be safely ignored) is preferably predetermined. In some embodiments, the list is referenced by the monitoring agent when determining whether a change has occurred and/or when determining how to handle a detected change. In other embodiments, the monitoring agent may be simply initially configured to not detect such changes. (For example, if the state is stored as a numeric vector corresponding to required text data fields, colour changes and other purely cosmetic changes would not be detectable.)

It should also be noted that the single system 10 may be configured to take only one of these actions, a subset of these actions, or any/all of these actions. That is, depending on the embodiment, some changes in website state may result in immediate, automatic adjustment to the mapping that is stored in the database 60. Other changes on the same website, determined by the same system 10 and the same monitoring agent(s), may be sent to a human operator for review, or simply ignored. Some embodiments of the system 10, however, may have only one possible action (e.g., providing feedback to the operator and requesting human review).

The website monitoring described above may occur at regular intervals, such as daily, weekly, monthly, semi-annual, annual, etc. Alternatively and/or additionally, monitoring and change detection processes may be performed on an ad-hoc or as-needed basis. For example, if a user designates the US State of Georgia to receive a tax submission, a monitoring agent may be configured to review the tax-submission platform associated with the State of Georgia. This as-needed review would determine whether any changes to the website state have occurred that might affect the mapping associated with the website (and that would or could thereby affect the user's tax submission attempt). Data Source

In some embodiments, the data source from which the user input/user data is retrieved is a database such as the database 60. In other embodiments, the data source is a third party system, such as an existing accounting system from which user input/user data is extracted. Further, in some embodiments, the data source may comprise one or more documents previously generated by a third party system. As a non-limiting example, where the system 10 is used for tax submissions, the data source may comprise previous tax filings saved on a user's device. Various automatic and autonomous methods may be used to retrieve user input from such sources. As well, in some embodiments, the data source may comprise a submission interface into which a user directly enters information.

Moreover, it should be understood that user input/user data may be retrieved from any/all of these potential data sources, depending on the embodiment. As a non-limiting example, a portion of the user data may be retrieved from saved documents, another portion of the user data may be retrieved from an external/third party system, and another portion of the user data may be directly submitted by a user using a submission interface.

In some embodiments, the submission interface is a standalone interface (i.e., is not connected to a larger data management system). For example, in some embodiments, the submission interface is an interface made available in a network browser application, such as an Internet browser. In other embodiments, the submission interface comprises a purpose-built, standalone computer application that may be executed on a desktop computer or on a mobile computing device.

In other embodiments, the submission interface is a part of or is associated with a larger data management system or is integrated or integrateable with a larger data management system. In such embodiments, the submission interface may be offered as an additional feature, aspect, or benefit of the larger system and may use data already available to the larger system. For example, in one embodiment, the database 60 is comprised in a larger database already available to the larger system. That larger database, in one embodiment, stores personal information of one or more users (such as names, addresses, SSN/SIN or other identifying numbers, login credentials for various websites, etc.). Of course, other (i.e., non-personal) data may also be available to the larger system, depending on the embodiment. Other information stored in such a larger system may also be retrievable as user data/user input, depending on the embodiment. For example, in the tax context, the submission interface may be associated with and/or integrated into an existing tax entry or accounting system. An example of such a tax entry system is presented in U.S. application Ser. No. 18/630,108 A, filed on Apr. 9, 2024, the entirety of which is herein incorporated by reference.

The submission interface is preferably capable of providing a number of notifications to the user both during and after data entry. As mentioned above, one type of notification may indicate that the submission/filing/application has been completed successfully. However, notifications may also include error notifications. For example, notifications during data entry may include warnings of an incorrect entry type, such as attempting to add text data to a numerical data field. Similarly, calculation and/or data agreement errors may be detected during data entry (e.g., if an amount of income tax paid exceeds total income, or if a claimed amount for a credit exceeds a claimable amount). In such a circumstance, the submission interface preferably provides a notification to the user and requests corrective action (e.g., new data entry). Additionally, in some embodiments, error notifications may be sent to operators/administrators of the system 10

Additionally, the software agent 30 may encounter difficulties when populating the tax authority website. For example, it may be the case that a website has changed but the mapping for that website has not yet been updated. In such a circumstance, a real-time submission interface may again request new data entry. However, in such a circumstance, an error notification may also be logged and/or sent to an operator / administrator of the system 10. Such an error notification preferably details the conflict between the expected entry field on the website and the actual entry field on the website, and thereby indicates a problem with the mapping for the relevant website. The mapping may then be edited/amended to reflect the actual entry fields on the websites (or to otherwise resolve the problem). In some embodiments, as described above, the editing/amendment of the mapping may be automatically performed, either with or without human review.

Further, it should be understood that a software agent as described herein may not be capable of completing an entire submission/filing/application process in one step. For example, the user may require additional information regarding, e.g., charitable donations or other financial activities for which receipts remain outstanding. Some form-based websites allow logged-in users to save draft or partial submissions. In such cases, the server 20 retrieves information that is available to it and directs the software agent(s) 30 to attend to partial submissions. The server 20 may notify the user after such a partial submission and note any required information that remains outstanding.

As well, a submission interface in some embodiments may provide a variety of helpful information and/or notifications, such as filing deadline(s) in jurisdictions of interest to each user. This may comprise a countdown and/or a series of notifications that increase in urgency as each deadline nears. Additional notifications may include explanatory content relating to specific filings/submissions/applications (e.g., in the tax context, explanatory information relating to particular deductions, credits, and/or taxable amounts), depending on the embodiment and depending on the jurisdiction(s). Additional notifications that may be provided by the submission interface, depending on the embodiment, include notifications or error warnings provided on the interface of the website form itself. That is, in some embodiments, the submission interface acts as a ‘relay’ to transmit notifications from the website / web portal to the user. In some embodiments, the user of the submission interface selects specific notifications or types of notifications that they wish to see and/or wish to hide. For example, the user may choose to ignore any notifications related to spelling errors in name fields, in some embodiments. Method Flowcharts

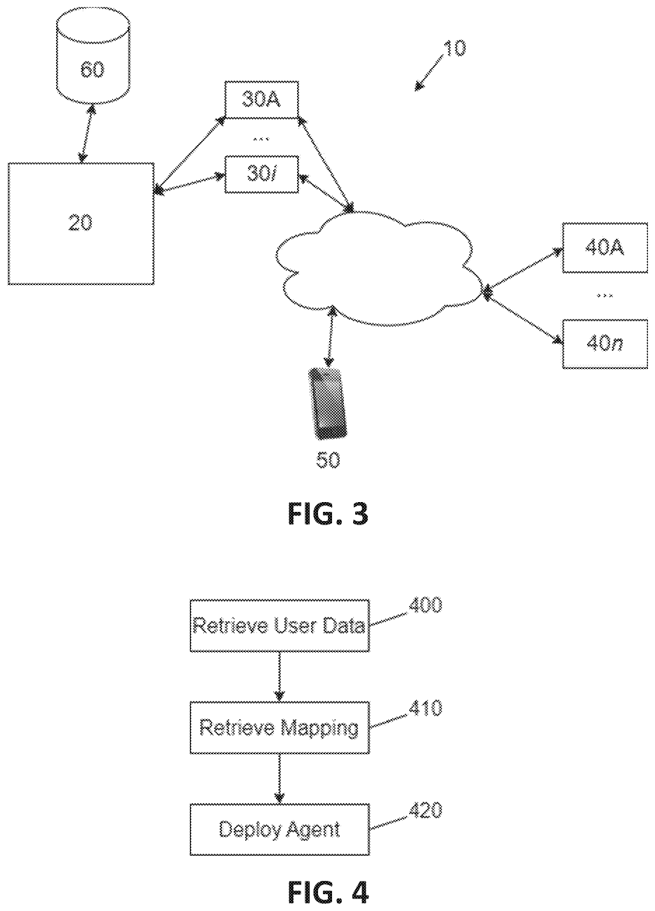

FIG. 4 is a flowchart detailing a method according to one aspect of the invention. User input/user data is retrieved at step 400 from at least one data source. At step 410, the mapping and/or other relevant information relating to the website is retrieved from a database. At least one software agent is deployed at step 420 and operates as described above, based on the user input and on the retrieved information.

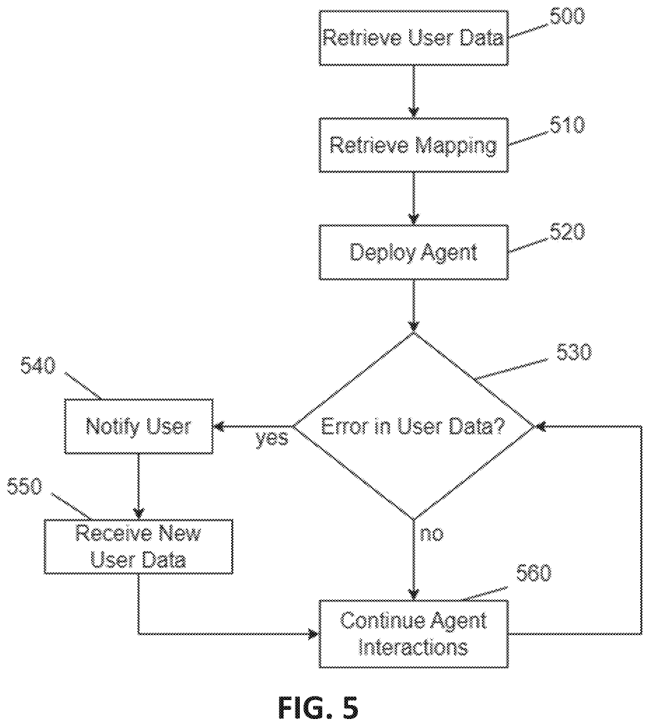

FIG. 5 is another flowchart detailing a further embodiment of the method. Steps 500 to 520 are the same as steps 400 to 420 of FIG. 4 described above. However, in some embodiments, an error in the user input is identified by the software agent while populating/attempting to populate the website (decision 530). When such an error is detected, the user is notified at step 540. At step 550, new user input is received. The agent continues to interact with the website at step 560, repeating the error-checking process as needed until the agent's interactions are complete.

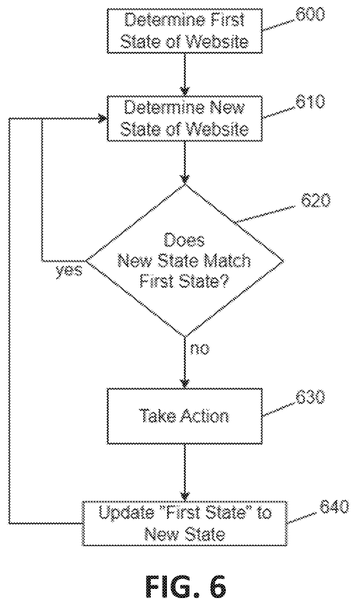

FIG. 6 is a flowchart detailing a method of website monitoring as described above. At step 600, a first state of the website is determined. A ‘new’ state of the website is determined at step 610. As described above, the new state may be determined at regular intervals and/or on an as-needed basis. The new state and the prior/first state of the website are compared to each other. If the new state matches the first state at decision 620 (i.e., no change in the state of the website is determined to have occurred), no action is taken and the method returns to step 610. Another new state will be determined at a later point. However, if the new state does not match the first state at decision 620 (i.e., a change in the state of the website is determined to have occurred), an action is taken at step 630. The action may comprise automatically adjusting information relating to the website and/or providing a notification to a human user as described above. The action may also comprise ignoring the change, as also described above, depending on the embodiment and/or on the nature of the change. The ‘new’/current state of the website is then set as the “first” state of the website (step 640), and the method returns to step 610. That is, when the state of the website is determined to have changed, the changed state is used as the baseline for later comparisons. This avoids redundant change detection. Interpretation

As used herein, the expression “at least one of [x] and [y]” means and should be construed as meaning “[x], [y], or both [x] and [y]”.

It should be clear that various aspects of the present invention may be implemented as software modules in an overall software system. As such, aspects of the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

Embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed:

1. A system for standardizing submissions to tax-filing websites, said system comprising:
a server configured to retrieve user data from a data source, said user data relating to at least one tax submission to be made to at least one of said tax-filing websites;
at least one software agent deployed over a network by said server, said at least one software agent being configured to interact with said at least one of said tax-filing websites; and
at least one database in communication with said server, said database storing information relating to said at least one of said tax-filing websites,
wherein interactions of said at least one software agent with said at least one of said tax-filing websites are based on said information stored in said at least one database,
and wherein said interactions relate to at least part of said at least one tax submission.

2. The system according to claim 1, wherein said source is at least one of:
said at least one database; an additional database; an external system; a third-party system; and a user interface receiving data input from a user in real or near-real time.

3. The system according to claim 1, wherein said server is further configured to monitor said at least one of said tax-filing websites and to thereby determine a state of said at least one of said tax-filing websites.

4. The system according to claim 3, wherein said server determines a change in said state of said at least one of said tax-filing websites.

5. The system according to claim 4, wherein said change in said state comprises a change in data requirements of said at least one of said tax-filing websites.

6. The system according to claim 4, wherein said server is further configured to provide feedback to an operator of said system, said feedback detailing said change in said state.

7. The system according to claim 5, wherein said server is further configured to automatically adjust said information in said database based on said change in said state.

8. The system according to claim 4, wherein said change in said state of said at least one of said tax-filing websites is recorded in said database.

9. The system according to claim 8, wherein said server is further configured to automatically adjust a user interface based on new information recorded in said database.

10. The system according to claim 1, wherein said at least one software agent comprises a plurality of software agents and wherein each of said plurality of software agents is configured to interact with a different tax-filing website.

11. The system according to claim 10, wherein multiple software agents of said plurality of software agents are deployed based on a single set of user data.

12. The system according to claim 11, wherein said multiple software agents operate simultaneously.

13. A method for standardizing submissions to tax-filing websites, said method comprising:
(a) retrieving, by a server, user data from a source, said user data relating to at least one tax submission to be made;
(b) receiving a designation of at least one tax authority;
(c) determining, by said server, a mapping of said user data to data fields of a tax-filing website of said at least one tax authority; and
(d) deploying, over a network using said server, a software agent configured to interact with said tax-filing website,
wherein said software agent interacts with said tax-filing website based on said mapping and on said user data, to thereby complete at least a part of said at least one tax submission based on said user data.

14. The method according to claim 13, wherein step (c) comprises retrieving at least part of said mapping from a database.

15. The method according to claim 13, wherein step (c) comprises generating at least part of said mapping using a mapping-capable software agent.

16. The method according to claim 13, further comprising monitoring said website to thereby determine a state of said tax-filing website.

17. The method according to claim 16, further comprising determining a change in said state of said tax-filing website.

18. The method according to claim 17, further comprising automatically adjusting said mapping based on said change in said state.

19. The method according to claim 13, further comprising deploying a plurality of software agents in step (c), wherein each of said plurality of software agents is configured to interact with a different tax-filing website.

20. A system for standardizing interactions with websites, said system comprising:
a server configured to retrieve user data from a data source, said user data relating to at least one submission to be made to at least one of said websites;
at least one software agent deployed over a network by said server, said at least one software agent being configured to interact with said at least one of said websites; and
at least one database in communication with said server, said database storing information relating to said at least one of said websites,
wherein interactions of said at least one software agent with said at least one of said websites are based on said information stored in said at least one database,
and wherein said interactions relate to at least part of said at least one submission.
